(19) United States
(12) Patent Application Publication
(10) Pub. No.: US 2019/0244064 A1
(43) Pub. Date: Aug. 8, 2019

(54) PATTERN RECOGNITION APPARATUS, METHOD AND MEDIUM

(71) Applicant: NEC Corporation, Minato-ku, Tokyo (JP)

(72) Inventors: Shivangi MAHTO, Tokyo (JP); Hitoshi YAMAMOTO, Tokyo (JP); Takafumi KOSHINAKA, Tokyo (JP)

(73) Assignee: NEC Corporation, Minato-ku, Tokyo (JP)

(21) Appl. No.: 16/344,096

(22) PCT Filed: Oct. 25, 2016
(86) PCT No.: PCT/JP2016/081510

§ 371 Date: Apr. 23, 2019

(51) Int. Cl. G06K 9/62; G06K 9/40; G06N 20/00

(52) U.S. Cl. CPC G06K 9/6267; G10L 15/02; G06N 20/00; G06K 9/40

(57) ABSTRACT

A pattern recognition apparatus according to the present invention includes: a memory; and at least one processor coupled to the memory, the processor performing operations, the operations comprising: transforming noisy feature vectors into denoised feature vectors; classifying the denoised feature vectors into related classes and estimated classes; calculating a cost by using the denoised feature vectors, clean feature vectors, the estimated classes, and feature vector labels; and updating parameters for transforming the noisy feature vectors according to the cost.

### TECHNICAL FIELD

The present invention relates to an apparatus, a method, and a medium for pattern recognition.

### BACKGROUND ART

Pattern recognition has been widely used in various spheres of life including day-to-day applications such as security, surveillance and e-commerce. Furthermore, pattern recognition has been used in technological applications such as agriculture, engineering, science and high profile issues like military and national security.

Processes of a pattern recognition system can be broadly categorized into two steps. The first step is feature extraction to extract features of the input signal. The second step is classification to classify the extracted features into a class (classes) corresponding to the input signals.

The pattern recognition system learns features corresponding to the classes and trains its classifier by using learnt features. For robust pattern recognition, features corresponding to a class should be similar to each other and features corresponding to different classes should be as dissimilar as possible. In technical terms, we can say features corresponding to the same classes should have low variance called as within class covariance and features belonging to different patterns should have large variance called as between class variance.

Real world scenarios noise (e.g. background noise, short duration and channel distortion) often affects performance of feature extraction and classification processes. Due to variety of noise, features can get corrupted and the expected property of small within class variance relative to between class variance cannot be satisfied.

One approach to keep the above mentioned expected property is as follows. The approach is to make within class variance or covariance in multi-dimensional cases as small as possible relative to between class covariance by transforming features into another feature space.

A feature transformation handles the problem of increased within class variance and/or decreased between class variance in the feature space due to distortion in input signal caused by noise. The feature transformation has been applied to the extracted features before classification where the desired feature space after transformation is to have small within class variance of features relative to between class variance.

Linear discriminant analysis has been a well-known classical approach to make within class variance smaller by feature transformation. Some new methods for feature transformation focus on either minimizing within class covariance or maximizing between class covariance using neural networks.

A pattern recognition apparatus 700 of related art for this method is disclosed in NPL2 as shown in FIG. 7. The pattern recognition apparatus 700 includes a feature transformer 710, an objective function calculator 730, a parameter updater 740, and a storage 750.

In training phase, the feature transformer 710 performs a function of a denoising autoencoder which takes noisy feature vectors as input and transforms them into denoised feature vectors. The objective function calculator 730 reads clean feature vectors and denoised feature vectors. The objective function calculator 730 calculates a cost of transformation from a mean square error between the denoised feature vectors and the clean feature vectors. The parameter updater 740 updates parameters of the feature transformer 710 (the denoising autoencoder) according to minimization of the cost. This process of the pattern recognition apparatus 700 keeps going till convergence. After convergence of the algorithm, the parameter updater 740 stores the parameters and structure of the feature transformer 710 (the denoising autoencoder) in the storage 750.

In testing phase, the feature transformer 710 reads the structure and the parameters from the storage 750, reads testing feature vectors, processes them and outputs denoised feature vectors.

Another pattern recognition apparatus 800 of related art which deals with feature transformation has been disclosed in NPL 1 as shown in FIG. 8. The pattern recognition apparatus 800 includes a classifier 820, an objective function calculator 830, a parameter updater 840, a storage 850, and a feature extractor 860.

In training phase, the classifier 820 receives training feature vectors and estimates their class labels. The objective function calculator 830 reads original feature vectors labels and the estimated class labels. The objective function calculator 830 calculates a cost of the classification from a classification error between the original labels and the estimated class labels. The parameter updater 840 updates parameters of the classifier 820 according to the minimization of the cost. This process of the pattern recognition apparatus 800 keeps going on till convergence. After convergence, the parameter updater 840 stores the parameters of the classifier 820 in the storage 850.

In testing phase, the feature extractor 860 reads the structure and the parameters of hidden layers of the classifier 820, reads testing feature vectors, and produces bottle neck feature vectors by taking output of last hidden layer.

The first method (NPL 2) focuses on denoising of feature vectors by using a denoising autoencoder which minimizes within class covariance of features. The second method (NPL 1) emphasizes on inculcating discriminability criteria by using bottle neck feature vectors from a Multilayer perceptron in transformed feature vectors which basically aims at maximizing between class covariance. The perceptron is one of pattern recognition machine which has been developed by Rosenblatt in 1958.

Above described methods aim to either minimize within class covariance or maximize between class covariance.

Other than the above-mentioned methods, there are some methods for pattern recognition (referring to PTL 1, PTL 2 and NPL3). PTL 1 discloses a learning device for pattern recognition by using a degree of scatter. PTL 2 discloses a pattern recognition method in which parameters to emphasize features are used. NPL3 discloses a method of speaker recognition.

### CITATION LIST

### Patent Literature

[PTL 1] Japanese Unexamined Patent Application Publication No. 2007-018176
[PTL 2] Japanese Unexamined Patent Application Publication No. 1996-106295

### Non Patent Literature

[NPL 1] Is,(s cedilla)ik, Yusuf Ziya, Hakan Erdogan, and Ruhi Sarikaya. “S-vector: A discriminative representation derived from i-vector for speaker verification.” Signal Processing Conference (EUSIPCO), 2015 23rd European. IEEE, 2015.
[NPL 2] H. Novoselov, Sergey, et al. “Non-linear PLDA for i-Vector Speaker Verification.” ISCA Interspeech (2015).
[NPL 3] Dehak, Najim, et al. “Front-end factor analysis for speaker verification.” IEEE Transactions on Audio, Speech, and Language Processing, Volume 19, Issue 4 (May 2011), pp. 788-798

### SUMMARY OF INVENTION

### Technical Problem

NPL 1 and NPL 2 don't handle within class covariance and between class covariance simultaneously. Denoising autoencoder does not maintain between class covariance criteria explicitly. Multilayer perceptron does not emphasize on minimizing within class covariance. Hence, in case of noisy testing features, it is uncertain that within class covariance will become small relative to between class covariance in the transformed feature space. Especially, the above is uncertain after applying either denoising autoencoder or bottle neck features of multilayer perceptron. This leads to low classification accuracy.

NPL 1 and NPL 2 have a problem in which classification accuracy becomes low.

PTL 1, PTL 2 and NPL 3 do not consider a cost disclosed in NPL1 or NPL2. PTL 1, PTL 2 and NPL 3 do not solve the above problem of PTL 1 and PTL 2.

The objection of the present invention is to provide a pattern recognition apparatus, a method and a medium that solve the above-mentioned problem and improve classification accuracy.

### Solution to Problem

A pattern recognition apparatus according one aspect of the present invention includes feature transform means for transforming noisy feature vectors into denoised feature vectors; classifying means for classifying the denoised feature vectors into their corresponding classes and estimating classes; objective function calculate means for calculating a cost using the denoised feature vectors, the clean feature vectors, the estimated classes, and feature vector laves; and parameter update means for updating parameters of the feature transform means according to the cost.

A pattern recognition method according one aspect of the present invention includes: transforming noisy feature vectors into denoised feature vectors; classifying the denoised feature vectors into their corresponding classes and estimating classes; calculating a cost using the denoised feature vectors, the clean feature vectors, the estimated classes, and feature vector laves; and updating parameters of the feature transform means according to the cost.

A computer readable medium according to one aspect of the present invention embodies a program. The program causes a pattern recognition apparatus to perform a method. The method includes: transforming noisy feature vectors into denoised feature vectors; classifying the denoised feature vectors into their corresponding classes and estimating classes; calculating a cost using the denoised feature vectors, the clean feature vectors, the estimated classes, and feature vector laves; and updating parameters of the feature transform means according to the cost.

### Advantageous Effects of Invention

According to the present invention, the invention can provide an effect of improving classification accuracy.

### BRIEF DESCRIPTION OF DRAWINGS

The drawings together with the detailed description, serve to explain the principles for the inventive. The drawings are for illustration and do not limit the application of the technique.

FIG. 1 is a block diagram illustrating a pattern recognition apparatus according to a first example embodiment of the present invention.

FIG. 2 is a block diagram illustrating a pattern recognition apparatus of a second example embodiment of the present invention.

FIG. 3 is a flowchart illustrating an example of an operation the pattern recognition apparatus according to the first example embodiment of the present invention in training phase.

FIG. 4 is a flowchart illustrating an example of an operation of the second example embodiment of the present invention in training phase.

FIG. 5 is a flowchart illustrating an example of an operation of the pattern recognition apparatus according to the first example embodiment of the present invention in testing phase.

FIG. 6 is a flowchart illustrating an example of an operation of the second example embodiment of the present invention in testing phase.

FIG. 7 is a block diagram of a configuration of related art 1.

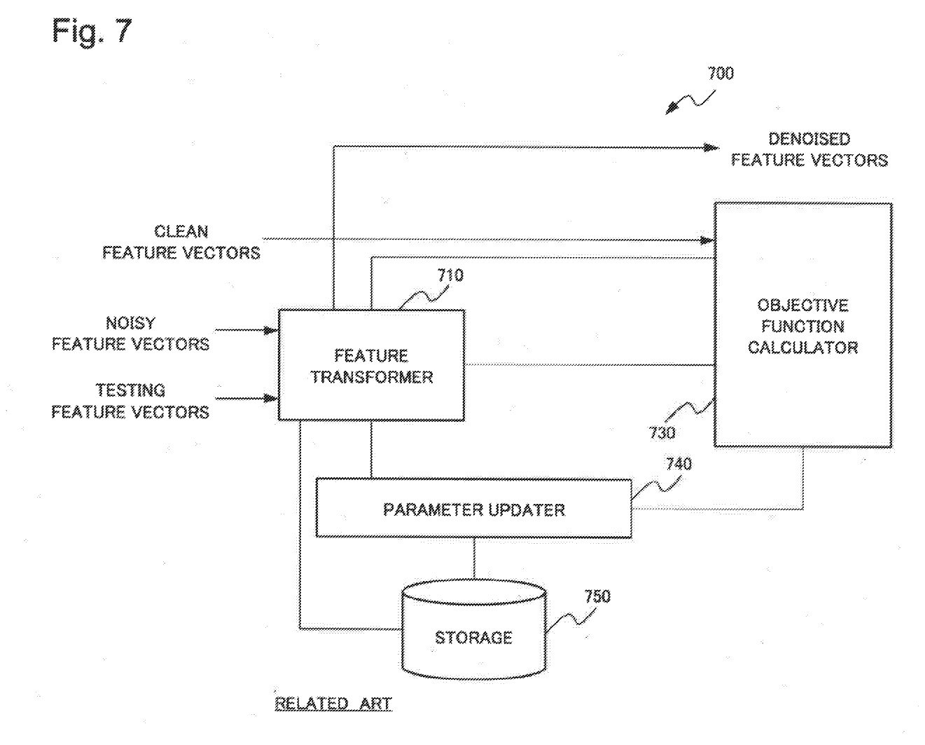

FIG. 8 is a block diagram of a configuration of related art 2.

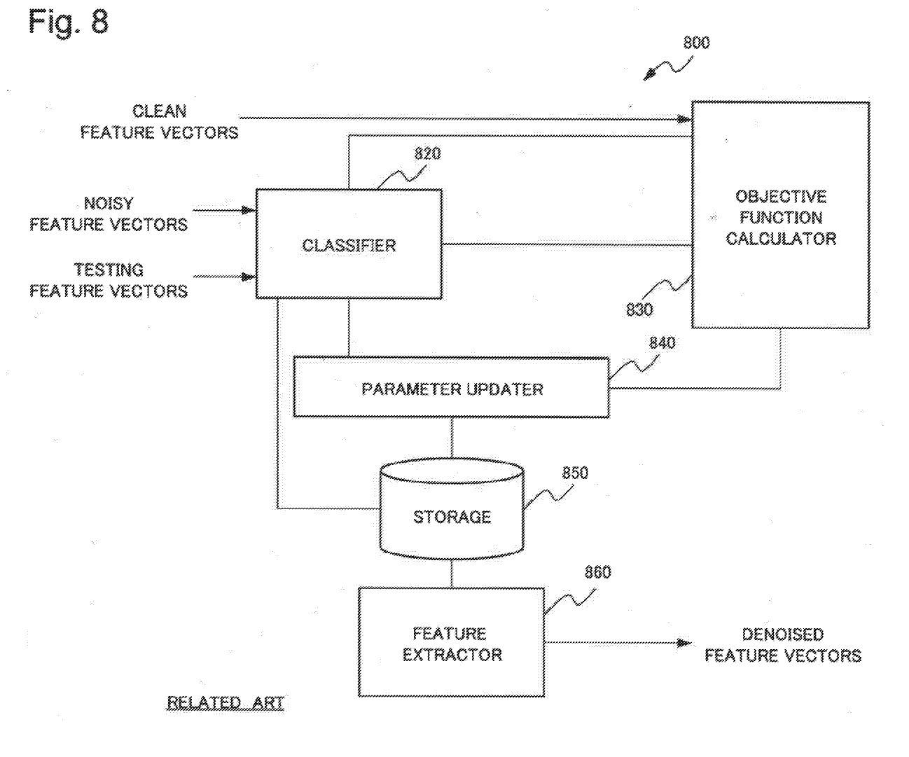

FIG. 9 is a block diagram illustrating a hardware configuration of the pattern recognition apparatus according to the first to second example embodiments.

FIG. 10 is a block diagram illustrating an outline configuration of the pattern recognition apparatus according to the first to second example embodiment.

### DESCRIPTION OF EMBODIMENTS

Hereinafter, example embodiments of the present invention will be described in detail. The implementations are described in complete detail. Along with the illustrative drawings, the explanation provided here is so as to provide a solid guide to a person skilled in the art to practice this invention.

### First Example Embodiment

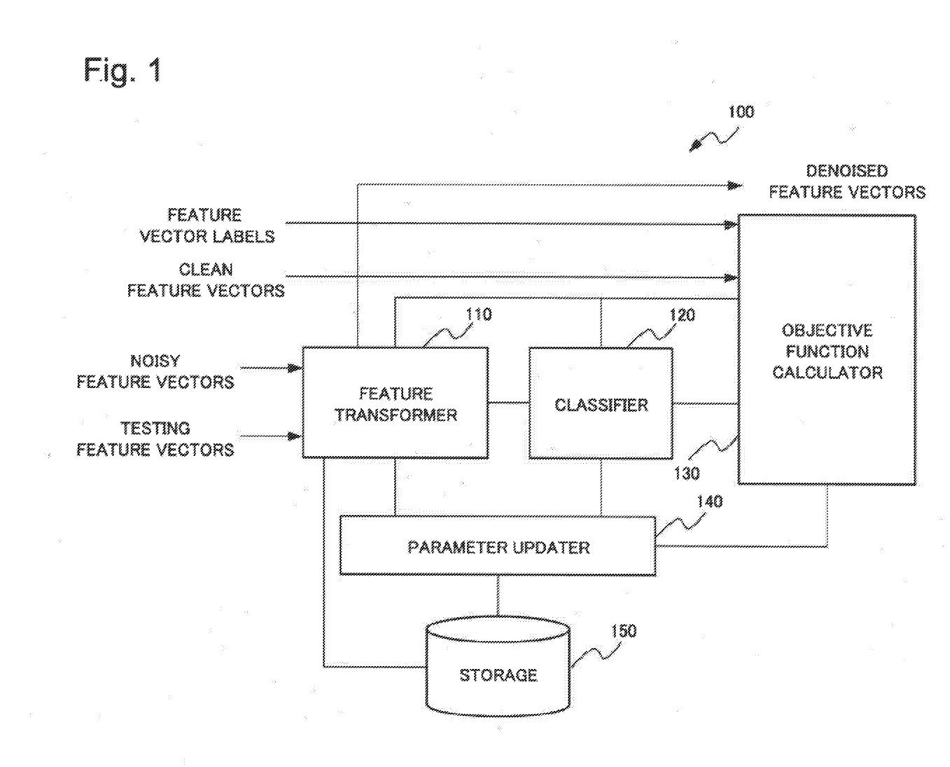

FIG. 1 is a block diagram illustrating a pattern recognition apparatus 100 according to a first example embodiment of the present invention. FIG. 1 illustrates two phases, that is, a training phase and a testing phase. Each of the phases will be described in detail later.

Referring to the FIG. 1, the pattern recognition apparatus 100 includes a feature transformer 110, a classifier 120, an objective function calculator 130, a parameter updater 140, and a storage 150.

In training phase, the feature transformer 110, the classifier 120, the objective function calculator 130, the parameter updater 140, and the storage 150 perform their processes. The objective function calculator 130 calculates a cost as a joint function of transformation error and classification error. The storage 150 stores parameters of the feature transformer 110.

In testing phase, the feature transformer 110 and a storage 150 perform their processes.

In the training phase, the feature transformer 110 transforms noisy feature vectors into denoised feature vectors.

The classifier 120 receives the denoised feature vectors from the feature transformer 110 and classifies them into their corresponding classes. The classifier 130 can be any classifier such as support vector machines or neural networks.

The objective function calculator 130 calculates a cost as weighted average of a transformation error and a classification error. The transformation error is calculated by using the denoised feature vectors with the clean feature vectors. The classification error is calculated by using the estimated classes of noisy feature vectors with the feature vector labels of classes. For example, the objective function calculator 130 may include an adder which calculates the cost by adding the transformation error and the classification error.

The objective function calculator 130 may use various equalities of cost. One example is the following equation 1.

$$Cost = α {\sum }_{j = 1}^{T} \frac{1}{D} {‖ {z}_{j} - {x}_{j} ‖}_{2}^{2} + ( 1 - α ) ( 0.5 {\sum }_{s = 1}^{N} {‖ {w}_{s} ‖}_{2}^{2} + C {\sum }_{j = 1}^{T} {( 1 - ( {w}_{{s}_{j}} {z}_{j} ) + {max}_{i \neq {s}_{j}} ( {w}_{i} {z}_{j} ) )}^{2} ) \qquad [ Equation 1 ]$$

Where x is the clean feature vector. z is the denoised feature vector. wₛ is weight corresponding to the output class s out of total N classes. D is the dimension of x and z. C is a scalar constant. α is a constant weight for the transformation error. N is number of classes. T is number of training data samples. ∥·∥₂² means a square of 2-norm. In maximization (max_{i≠sj} (wᵢzⱼ):
a. sⱼ is the class to which j-th training sample belongs to and it is a known data as given input to the system.
b. i denotes the class out of all possible N classes except s which gives maximum value for (wᵢzⱼ). The (wᵢzⱼ) is an operation between wᵢ and zⱼ. The operation between wᵢ and z₃ is inner product.
c. The parameter updater (d) determines i.

In the above equation 1, the first term is a transformation error. The transformation error comes from the feature transformer component of figure of proposed embodiments. Furthermore, the transformation error is a sum of 2-norms. That is, the transformation error is mean square error. The mean square error is an average of square of error between expected value and estimated value. For example, any kind of distance measures like the following cosine distance can be applied for the transformation error.

### [Cosine Distance]

$$\frac{( xz )}{‖ x ‖ ‖ z ‖}$$

where operator ‘(xz)’ represents an inner product between denoised vector z and corresponding clean feature vector x and operator (∥×∥) represents magnitude of the vector x.

The classification error is a margin error but it can be any classification error like cross-entropy as following:

cross−entropy=−l log(o)−(1−l)log(1−o)

where 1 denote a specific class to which input ‘feature vector’ corresponding to. o signifies the label estimated classes estimated by the classifier 120. o should be ideally equal to 1 of the input feature vector. It should be noted that each of labels is a scalar value and assigned to each of classes. Namely, 1 and o are scalar values. Furthermore, Log base can take any value. For example, Log may be a natural log.

The feature transformer 110 can be a denoising autoencoder. The parameters of the feature transformer 110 is included in z.

The parameter updater 140 updates the parameters of the feature transformer 110 and the classifier 120 according to the cost which is minimized by using popular numerical methods such as back propagation. This process of the pattern recognition apparatus 100 keeps going till convergence when the cost can be reduced no more. After convergence, the parameter updater 140 stores the parameters of the trained feature transformer 110 in the storage 150. The parameter updater 140 or the feature transformer 110 may store structure of the feature transformer 110.

In the testing phase, the feature transformer 110 reads the parameters from the storage 150. Then, by using the parameters, the feature transformer 110 reads testing feature vectors as input and produces denoised feature vectors as output. When the structure of the feature transformer 110 is stored, the feature transformer 110 may read the structure at the same time of reading the parameters.

In the case of face recognition, for example, classes are personal identifiers (IDs) and feature vectors are coordinates of eyes, noses and so on. If the images to be recognized are blurred while the recognition system is trained on clean images then these pictures will not be recognized properly. These blurred images would produce noisy features in feature space as compared to the features extracted from clean images which were used for training of pattern recognition system.

The feature transformer 110 reads the noisy feature vectors corresponding to blurred images and produces the denoised feature vectors.

In the case of speaker recognition, for example, classes are also personal IDs of speakers and feature vectors are i-vectors which are extracted from phonemes included in speech signals, as shown in NPL3. When the system is applied to the audios recorded in a noisy environment, the systems reads noisy i-vectors as features of the speaker whereas the system is trained on clean i-vectors extracted from clean audio signals.

The feature transformer 110 transforms noisy i-vectors into clean i-vectors which will be further used in the standard pattern recognition system to recognize speakers.

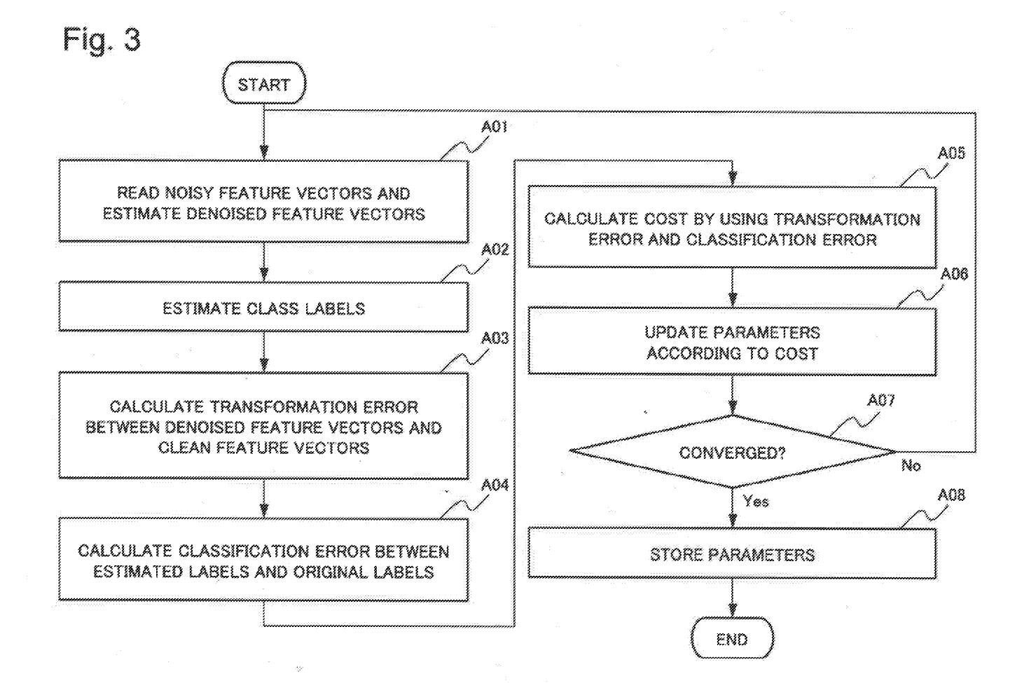

FIG. 3 is a flowchart illustrating an example of operation of the pattern recognition apparatus 100 according to the first example embodiment of the present invention in the training phase.

First, the feature transformer 110 reads the noisy feature vectors and estimates the denoised feature vectors (A01). That is, the feature transformer 110 transforms the noisy feature vectors into the denoised feature vectors.

The classifier 120 receives the denoised feature vectors. The classifier 120 estimates class labels of the denoised feature vectors (A02). That is, the classifier 120 classifies the denoised feature vectors into their corresponding classes.

The objective function calculator 130 calculates the transformation error between the denoised feature vectors and the clean feature vectors (A03).

Then, the objective function calculator 130 calculates the classification error between the estimated class labels and the feature vectors labels (original labels) (A04).

The objective function calculator 130 calculates a cost by using the transformation error and the classification error (A05).

The parameter updater 140 updates parameters of the feature transformer 110 and the classifier 120 according to the cost (A06).

This process keeps going till convergence when the cost can be reduced no more (A07).

After convergence, the parameter updater 140 stores parameters of the feature transformer 110 into the storage 150 (A08). At this time, the parameters of the feature transformer 110 are trained. Consequently, the feature transformer 110 is trained.

The pattern recognition apparatus 100 can perform step A03 before A02, because the operations from step A01 to step A02 are independently performed with the operation from step A03 to step A04.

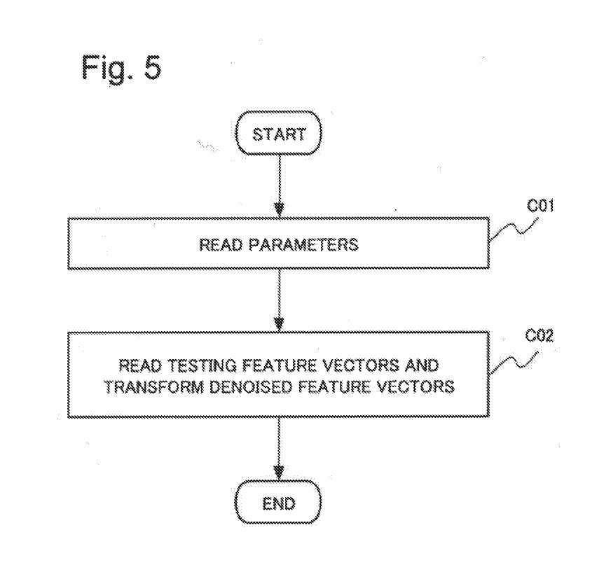

FIG. 5 is a flowchart illustrating an example of an operation of the pattern recognition apparatus 100 according to the first example embodiment of the present invention in the testing phase.

First, the feature transformer 110 reads the parameters from the storage 150 (C01).

Then, the feature transformer 110 reads testing feature vectors as input and transforms them into the denoised feature vectors as output by using the parameters (C02). The denoised feature vectors can then be given to some classifier to be classified to an appropriate class.

The pattern recognition apparatus 100 has an effect of improving classification accuracy.

This is because of following reason. The feature transformer 110 estimates the denoised feature vectors. The classifier 120 estimates the class labels of the denoised feature vectors. The objective function calculator 130 calculates the transformation error and the classification error, and calculates a cost by using the transformation error and the classification error. Then, the parameter updater 140 updates the parameters of the feature transformer 110 according to the cost. The classification error relates with class covariance. That is, the pattern recognition apparatus 100 maintains class covariance.

To handle distortion in input signals, a noise robust pattern recognition system is very important. Distortion in input signal due to noise and other factors can cause large within class covariance relative to between class covariance in feature space which results in worse pattern recognition accuracy. One of the important properties of features for good pattern recognition is to have small within class covariance relative to between class covariance.

There exist approaches in NPL1 and NPL 2 for feature transformation. NPL 1 and NPL 2 try to solve the problem but they also suffer from some drawbacks as follows. They do not optimize within class covariance and between class covariance simultaneously. In many real applications of pattern recognition systems, the input signal has noise. Consequently, pattern recognition systems which include the input signal can have large within class covariance and large between class covariance. Hence, only concentrating on optimizing any one covariance cannot solve the problem.

It is important to handle the problem of maintaining within class covariance small relative to between class covariance for noisy input signal. The present example embodiment can transform extracted noisy feature vectors to another space (classes). This operation is performed with joint minimization of feature denoising error and feature classification error which emphasize on minimizing within class covariance and maximizing between class covariance simultaneously. Then, the present example embodiment minimizes a cost according to the transformation error and the classification error.

In this way, the pattern recognition apparatus 100 improves classification accuracy because the parameter updater 140 updates the parameters of the feature transformer 110. Furthermore, the pattern recognition apparatus 100 performs the above-mentioned operation by using the cost according to the transformation error and the classification error.

### Second Example Embodiment

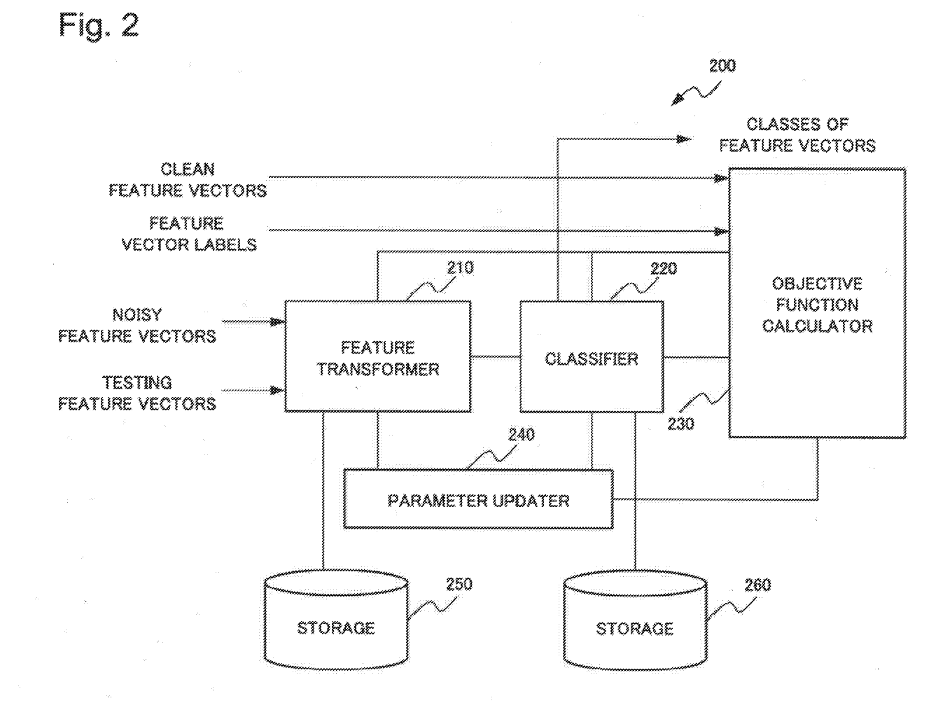

FIG. 2 is a block diagram illustrating a pattern recognition apparatus 200 according to a second example embodiment of the present invention.

Referring to the FIG. 2, the pattern recognition apparatus 200 includes a feature transformer 210, a classifier 220, an objective function calculator 230, a parameter updater 240, a storage 250, and a storage 260.

In training phase, the feature transformer 210, the classifier 220, the objective function calculator 230, the parameter updater 240, the storage 250 and the storage 260 perform their processes. The objective function calculator 230 calculates cost as a joint function of transformation error and classification error.

In testing phase, the feature transformer 210, the classifier 220, the storage 250, and the storage 260 perform their processes.

In the training phase, the feature transformer 210 transforms input noisy feature vectors into denoised feature vectors.

The classifier 220 receives the denoised feature vectors and classifies them into their corresponding classes.

The objective function calculator 230 calculates a cost by using the transformation error and the classification error. The transformation error is calculated by using the denoised feature vectors with the clean feature vectors. The classification error is calculated by using the estimated classes of noisy feature vectors with the feature vector labels (original labels of classes).

The parameter updater 240 updates parameters of the feature transformer 210 and the classifier 220 according to the cost in the manner that the cost is minimized. This process keeps going till convergence when the cost can be reduced no more.

After convergence, the storage 250 stores the parameters of the trained feature transformer 210. The storage 260 stores the parameters of the classifier 220. The parameter updater 240 or the feature transformer 210 may store structure of the feature transformer 210 into the storage 250. The parameter updater 240 or the classifier 220 may store structure of the classifier 220 to the storage 260. The storage 250 and the storage 260 may be achieved by using a same storage device.

In the testing phase, the feature transformer 210 reads the parameters from the storage 250. Then, by using the parameters, the feature transformer 210 reads testing feature vectors as input and produces denoised feature vectors as output. When the structure of the feature transformer 210 is stored, the feature transformer 210 may read the structure at the same time of reading the parameters.

Then, the classifier 220 reads the parameters from the storage 260. By using the parameter, the classifier 220 reads denoised feature vectors as input and estimates classes of feature vectors as output. When the structure of the classifier 220 is stored, the classifier 220 may read the structure at the same time of reading the parameters.

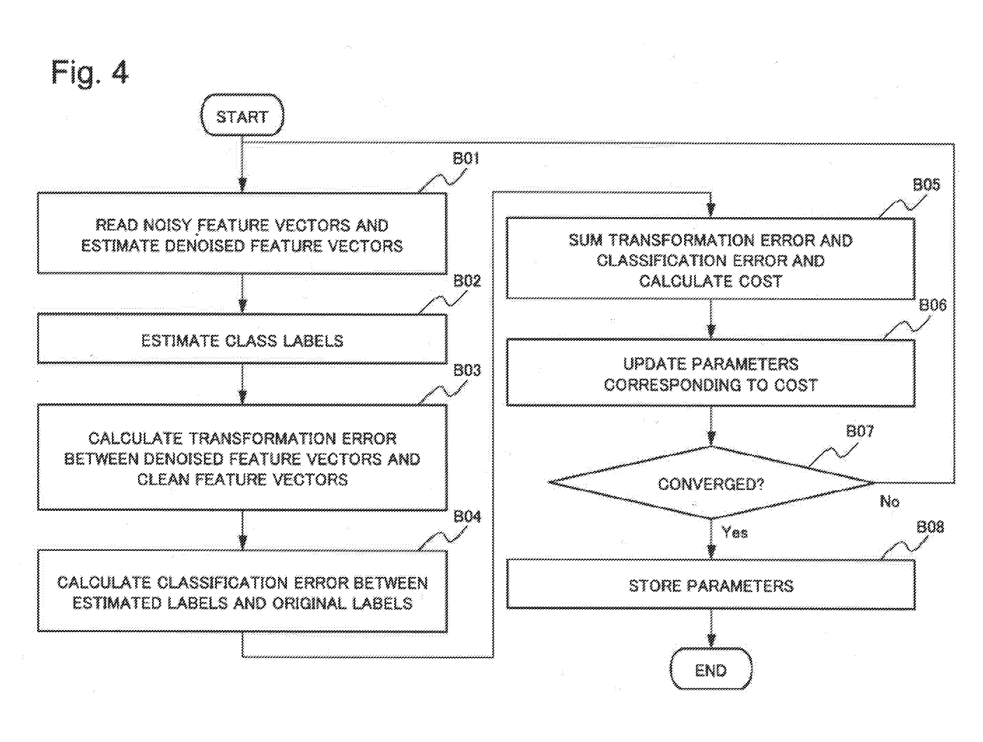

FIG. 4 is a flowchart illustrating an example of operation of the pattern recognition apparatus 200 according to the second example embodiment of the present invention in training phase.

First, the feature transformer 210 reads the noisy feature vectors and estimates the denoised feature vectors (B01). That is, the feature transformer 210 transforms the noisy feature vectors into the denoised feature vectors.

The classifier 220 receives the denoised feature vectors. The classifier 220 estimates class labels of the denoised feature vectors (B02). That is, the classifier 220 classifies the denoised feature vectors into their corresponding classes.

The objective function calculator 230 calculates the transformation error between the denoised feature vectors and the clean feature vectors (B03).

Then, the objective function calculator 230 calculates the classification error between the estimated class labels and the feature vector labels (original labels) (B04).

The objective function calculator 230 calculates a cost by using the transformation error and the classification error (B05).

The parameter updater 240 updates parameters of the feature transformer 210 and the classifier 220 according to the cost (B06).

This process keeps going till convergence when the cost can be reduced no more (B07).

After convergence, the parameter updater 240 stores parameters of the feature transformer 210 and the classifier 220 in the storage 250 and the storage 260, respectively (B08). At this time, the parameters of the feature transformer 210 and the classifier 220 are trained. Consequently, the feature transformer 210 and the classifier 220 are trained.

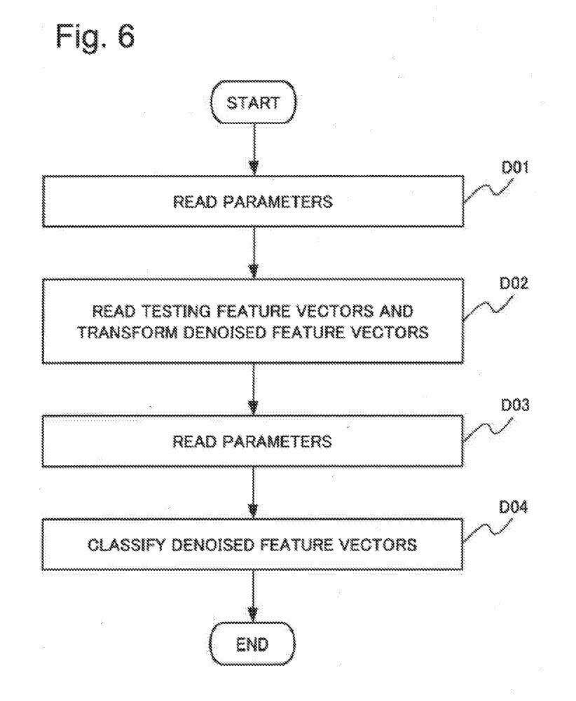

FIG. 6 is a flowchart illustrating an example of an operation of the pattern recognition apparatus 200 according to the second example embodiment of the present invention in the testing phase.

First, the feature transformer 210 reads the parameters from the storage 250 (D01).

Then, the feature transformer 210 reads testing feature vectors as input and transforms them into the denoised feature vectors as output (D02).

The classifier 220 reads the parameters from the storage 260 (D03).

Then, the classifier 220 reads the denoised feature vectors as input and estimates classes of feature vectors as output (D04).

The pattern recognition apparatus 200 has an effect of improving classification accuracy.

This is because of the following reason. The feature transformer 210 estimates the denoised feature vectors. The classifier 220 estimates the class labels of the denoise feature vectors. The objective function calculator 230 calculates the transformation error and the classification error, and calculates a cost by using the transformation error and the classification error. Then, the parameter updater 240 updates the parameters of the feature transformer 210 according to the cost. The classification error relates with class covariance. That is, the pattern recognition apparatus 200 maintains class covariance.

<Hardware>

The pattern recognition apparatus 100 and 200 according to the first to the second example embodiments are configured as shown in the following.

For example, each of components of the pattern recognition apparatus 100 and 200 may be configured with a hardware circuit.

Alternatively, in the pattern recognition apparatus 100 and 200, each of components may be configured by using a plurality of devices which are connected through a network.

Alternatively, in the pattern recognition apparatus 100 and 200, a plurality of components may be configured with single hardware.

Alternatively, the pattern recognition apparatus 100 and 200 may be realized as a computer device which includes a Central Processing Unit (CPU), a Read Only Memory (ROM), and a Random Access Memory (RAM). Furthermore, the pattern recognition apparatus 100 and 200 may be realized as a computer device which includes an Input and Output Circuit (IOC) and a Network Interface Circuit (NIC) in addition to the above-mentioned components.

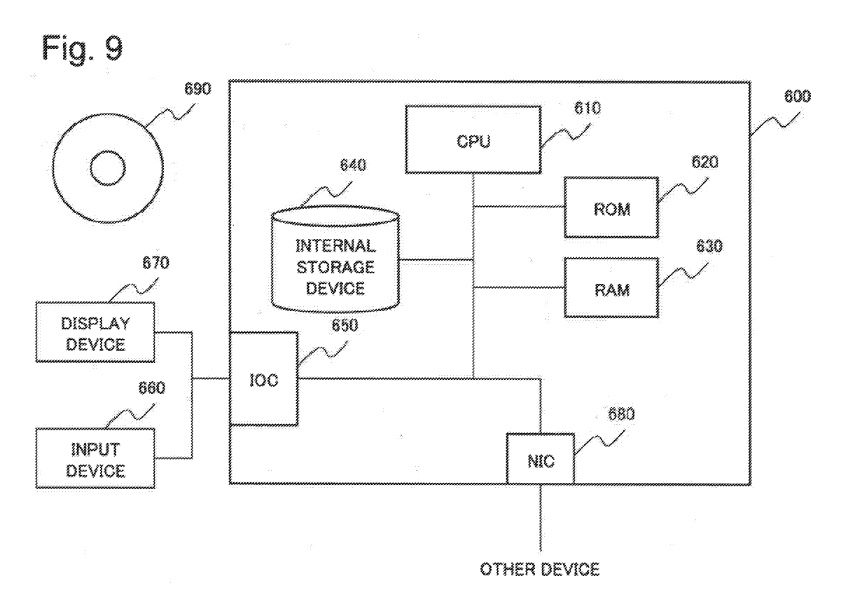

FIG. 9 is a block diagram showing an example of hardware configuration of an information-processing device 600 as the pattern recognition apparatus 100 and 200.

The information-processing device 600 includes a CPU 610, a ROM 620, a RAM 630, an internal storage device 640, an IOC 650, and a NIC 680 to configure a computer device.

The CPU 610 reads out a program from the ROM 620. Then, the CPU 610 controls the RAM 630, the internal storage device 640, the IOC 650, and the NIC 680 based on the read program. Then, the computer device including the CPU 610 controls the components, and realizes each function as each component shown in FIG. 1 to FIG. 2.

When realizing each function, the CPU 610 may use the RAM 630 or the internal storage device 640 as a temporary storage of the program.

Alternatively, the CPU 610 may read out the program included in a storage medium 690 which stores the program so as to be computer-readable, by using a storage medium reading device not shown in the drawing. Alternatively, the CPU 610 receives the program from an external device not shown in the drawing through the NIC 680, and stores the program into the RAM 630, and operates based on the stored program.

The ROM 620 stores the program executed by the CPU 610, and fixed data. The ROM 620 is, for example, a programmable-ROM (P-ROM), or a flash ROM.

The RAM 630 temporarily stores the program executed by the CPU 610, and data. The RAM 630 is, for example, a dynamic-RAM (D-RAM).

The internal storage device 640 stores data and the program which the information-processing device 600 stores for a long period. Furthermore, the internal storage device 640 may operate as a temporary storage device of the CPU 610. The internal storage device 640 is, for example, a hard disc device, a magneto-optical disc device, SSD (Solid State Drive), or a disc array device.

Here, the ROM 620 and the internal storage device 640 are a non-transitory storage media. Meanwhile, the RAM 630 is a transitory storage medium. The CPU 610 can execute based on the program which the ROM 620, the internal storage device 640, or the RAM 630 stores. That is, the CPU 610 can execute by using the non-transitory storage medium or the transitory storage medium.

The IOC 650 mediates data between the CPU 610 and an input device 660, and between the CPU 610 and a display device 670. The IOC 650 is, for example, an I/O interface card, or a USB (Universal Serial Bus) card.

The input device 660 is a device which receives an input instruction from an operator of the information-processing device 600. The input device 660 is, for example, a keyboard, a mouse, or a touch panel.

The display device 670 is a device which displays information for the operator of the information-processing device 600. The display device 670 is, for example, a liquid-crystal display.

The NIC 680 relays data communication with an external device, which is not shown in the drawing, through a network. The NIC 680 is, for example, a local area network (LAN) card.

The information-processing device 600 which is configured in this manner can achieve an effect as same as the pattern recognition apparatus 100 and 200.

The reason is that the CPU 610 of the information-processing device 600 can realize the same functions of the pattern recognition apparatus 100 and 200 based on the program.

### Outline of Example Embodiments

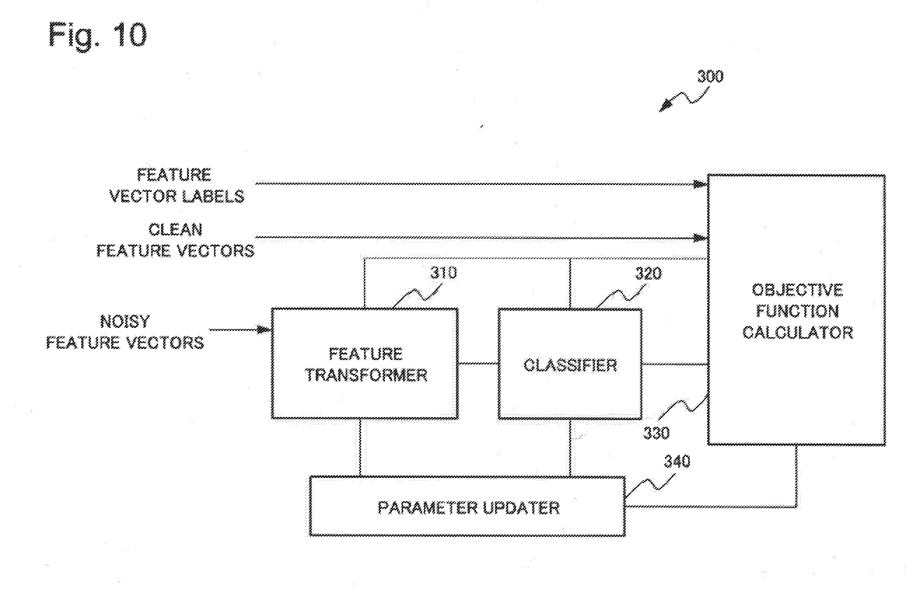

Hereinafter, outline of example embodiments of the present invention will be described. FIG. 10 is a block diagram illustrating an outline of a pattern recognition apparatus 300 of the first and the second example embodiments of the present invention.

Referring to the FIG. 10, the pattern recognition apparatus 300 includes a feature transformer 310, a classifier 320, an objective function calculator 330, and a parameter updater 340.

The feature transformer 310 transforms noisy feature vectors into denoised feature vectors.

The classifier 320 classifies the denoised feature vectors into their corresponding classes and estimates classes.

The objective function calculator 330 calculates a cost using the denoised feature vectors, the clean feature vectors, the estimated classes, and feature vector label.

The parameter updater 340 updates parameters of the feature transformer 310 according to the cost.

The pattern recognition apparatus 300 has an effect of improving classification accuracy like the pattern recognition apparatus 100 and the pattern recognition apparatus 200. This is because of that units of the pattern recognition apparatus 300 performs same operations like those of the pattern recognition apparatus 100 and the pattern recognition apparatus 200.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

100 Pattern recognition apparatus
110 Feature transformer
120 Classifier
130 Objective function calculator
131 Transformation error
132 Classification error
133 Cost
134 Adder
140 Parameter updater
150 Storage
200 Pattern recognition apparatus
210 Feature transformer
220 Classifier
230 Objective function calculator
240 Parameter updater
250 Storage
260 Storage
300 Pattern recognition apparatus
310 Feature transformer
320 Classifier
330 Objective function calculator
340 Parameter updater
600 Information-processing device
610 CPU
620 ROM
630 RAM
640 Internal storage device
650 IOC
660 Input device
670 Display device
680 NIC
690 Medium
700 Pattern recognition apparatus
710 Feature transformer
730 Objective function calculator
740 Parameter updater
750 Storage
800 Pattern recognition apparatus
820 Classifier
830 Objective function calculator
840 Parameter updater
850 Storage
860 Feature extractor

What is claimed is:

1. A pattern recognition apparatus comprising:
a memory; and
at least one processor coupled to the memory,
the processor performing operations, the operations comprising:
transforming noisy feature vectors into denoised feature vectors;
classifying the denoised feature vectors into related classes and estimated classes;
calculating a cost by using the denoised feature vectors, clean feature vectors, the estimated classes, and feature vector labels; and
updating parameters for transforming the noisy feature vectors according to the cost.

2. The pattern recognition apparatus according to claim 1, wherein the operations further comprises
transforming testing feature vectors into the denoised feature vectors by using the updated parameters for transforming the noisy feature vector.

3. The pattern recognition apparatus according to claim 2, wherein the operations further comprises
updating parameters for classifying the denoised feature vectors, and
classifying the denoised feature vectors by using the updated parameters for classifying the denoised feature vectors.

4. The apparatus according to claim 1, wherein the operations further comprises
calculating the cost by using a transformation error between the denoised feature vectors and clean feature vectors and a classification error between estimated classes of noisy the noisy feature vectors and feature vector labels of classes.

5. The apparatus according to claim 1, wherein the operations further comprises
transforming the noisy feature vectors by using a denoising autoencoder.

6. The apparatus according to claim 1, wherein the operations further comprises
classifying the denoised feature vectors by using a support vector machine or a neural network.

7. The apparatus according to claim 4, wherein
the transformation error is mean square error or cosine distance.

8. The apparatus according to claim 4, wherein
the classification error is cross-entropy or margin error.

9. A pattern recognition method comprising:
transforming noisy feature vectors into denoised feature vectors;
classifying the denoised feature vectors into related classes and estimated classes;
calculating a cost by using the denoised feature vectors, clean feature vectors, the estimated classes, and feature vector labels; and
updating parameters for transforming the noisy feature vector according to the cost.

10. A non-transitory computer readable medium embodying a program, the program causing a pattern recognition apparatus to perform a method, the method comprising:
transforming noisy feature vectors into denoised feature vectors;
classifying the denoised feature vectors into related classes and estimated classes;
calculating a cost by using the denoised feature vectors, clean feature vectors, the estimated classes, and feature vector labels; and
updating parameters for transforming the noisy feature vector according to the cost.
